(19) United States
(12) Patent Application Publication
(10) Pub. No.: US 2011/0019062 A1
(43) Pub. Date: Jan. 27, 2011

(54) Optical Element Assembly, Image Pickup Module, and Method for Manufacturing Electronic Apparatus

(76) Inventor: Mika Honda, Tokyo (JP)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/933,931

(22) PCT Filed: Mar. 23, 2009
(86) PCT No.: PCT/JP2009/055603

§ 371 Date: Sep. 22, 2010

(30) Foreign Application Priority Data
Mar. 27, 2008 (JP) 2008-083864

(51) Int. Cl. G02B 13/16; G02B 3/00; B23K 1/00

(52) U.S. Cl. 348/335; 359/642; 228/245; 348/E05.024

(57) ABSTRACT

Provided is an optical element assembly which is composed of two or more optical members and can prevent one optical member from being separated from another even if the optical element assembly is subjected to reflow processing, and also provided are an image pickup module using the optical element assembly, and a method for manufacturing an electronic apparatus including the image pickup module. There is provided an optical element assembly in which a first optical member formed of glass or curable resin and a second optical element formed of curable resin are joined together, and the following expression (1) is satisfied, where α₁ (×10⁻⁶ ppm/° C.) is a coefficient of linear expansion of the first optical member and α₂ (×10⁻⁶ ppm/° C. ) is a coefficient of linear expansion of the second optical member:

|α₁−α₂|≦100 (1).

### TECHNICAL FIELD

The present invention relates to an optical element assembly, an image pickup module, and a method for manufacturing an electronic apparatus, and, in particular, to a technology suitably used for reflow processing.

### BACKGROUND ART

Heretofore, glass has generally been used as a constitutional material of an optical element (mainly a lens) from the viewpoint of excellent optical properties and mechanical strength. However, with the decrease in size of an apparatus in which an optical element is used, it has also become required to decrease in size of the optical element itself. Since it is difficult to make a product having an aspheric shape or a complicated shape using the glass, the glass has become unsuitable for the mass-production of precision elements.

Due to the above reasons, there have been studied or used plastic materials which are easily processed. The aforesaid plastic materials include thermoplastic resins having excellent transparency such as polyolefin, polymethymethacrylate, polycarbonate, and polystyrene, and are usually produced using a metal mold via an injection molding.

On the other hand, there has been proposed a technology (for example, refer to Patent Literature 1) that, in case where an IC (Integrated Circuits) chip and other electronic components are mounted on a circuit board, an electroconductive material (for example, a solder) is applied in advance to the prescribed positions of the circuit board (potting process), and the aforesaid circuit board is subjected to a reflow processing (being a heating processing) with the electronic components being placed on the positions, to mount the electronic components on the aforesaid circuit board by melting the electroconductive material, whereby it has become possible to produce an electronic module at low cost.

In recent years, there has also been proposed a technology that the above reflow processing is carried out in a state that an optical element is further placed on the circuit board additionally to electronic components, and then, the electronic components and the optical element are simultaneously mounted on the circuit board. Thereby, in a production system of electronic apparatuses (optical devices), further improvement in production efficiency has been desired. Naturally, in electronic apparatuses produced by a production system incorporating the above reflow processing, it is desired to use plastic optical elements, which can be produced with low cost, rather than the high-cost glass optical elements.

However, though thermoplastic resins, which are used in place of glass, have excellent processing properties, they have defects that a formed optical element is easily deformed with heat, since it tends to become soft or melt at relatively low temperature. In case where an electronic component in which optical elements are incorporated (an image pickup module), is mounted on a board by reflow processing, the optical elements themselves are exposed to heat environment of about 260° C. Therefore, in such a case, the shape of the optical element composed of thermoplastic resin exhibiting a low heat resistance is easily changed, whereby it is difficult to make them demonstrate the primary optical properties.

Therefore, the present inventors have studied the use of “thermosetting resin” and “photo-curable resin” as plastic materials for optical elements used for electronic apparatuses produced with reflow processing. Thermosetting resin and photo-curable resin are liquid or exhibit fluidity before being cured, and therefore they have excellent processing property like thermoplastic resin. Further, since thermosetting resin and photo-curable resin do not exhibit fluidity like thermoplastic resin after being cured, their deformation due to heat is minimized.

However, if an optical element which is applicable to reflow processing, is formed only of thermosetting resin or photo-curable resin, there may be a case where heat or light does not reach the center part thereof in a curing process (a forming process). In this case, variation in degree of cure is generated at each portion in the optical element, resulting in variation in refractive index at each of the portions, and there is a limit to constitute the whole optical element with one type of resin as a result.

Under such circumstances, there has been studied a technology that there is provided an assembly of glass and resin by preparing a glass plate as a base optical member and arranging an optical member formed of thermosetting resin on the glass plate, to obtain an optical element (an optical element assembly) which has high heat resistance and is applicable to reflow processing (for example, refer to Patent Literature 2). Namely, according to the technology of Patent Literature 2, since a glass plate is used as an optical member for a base, there is little necessity for considering the processing property of an aspheric shape or a complicated shape, whereby it is possible to overcome a shortcoming of inferiority in mass-production. At the same time, since the technology provides a constitution that an optical member made of a thermosetting resin is placed on the above glass plate, the amount of resin used can be minimized (the thickness of a resin layer can be made thin), thereby generation of variation of the refractive index originated in variation in degree of cure can be restrained. As a result, it is assumed that existing problems originated in conventional materials themselves can be swept away.

Patent Literature 1: Japanese Patent Application Publication (hereinafter also referred to as JP-A) No. 2001-24320

Patent Literature 2: Japanese Patent No. 3926380

### DISCLOSURE OF INVENTION

### Problems to be Solved by the Invention

However, in the technology of Patent Literature 2, silicon resin is used as thermosetting resin (refer to the paragraph 0054), and the difference of coefficients of linear expansion between glass and silicon resin is large. Even in such the case, no particular problem was encountered in the temperature changes in the general use. However, it has been hind that, in case where the aforesaid optical element assembly was subjected to reflow processing, deformation was generated at a lens section of the optical member which was taken out, and there was caused a phenomenon that the lens section formed on the glass plate was separated from the surface of the glass plate which was an optical member for a base.

Consequently, a main purpose of the present invention is to provide an optical element assembly which is composed of at least two optical members and can prevent one optical member from being separated from another even if the optical element assembly is subjected to reflow processing, and at the same time, to provide a method of manufacturing an image pickup module using the aforesaid optical element assembly and an electronic apparatus incorporating the image pickup module.

Means to Solve the Problems

According to one embodiment of the present invention, there is provided an optical element assembly comprising: a first optical member formed of glass or curable resin; and a second optical member formed of a curable resin, wherein the first optical member and the second optical member are joined together. The optical element assembly satisfies a condition represented by Expression (1), where α₁ (×10⁻⁶ ppm/° C.) is a coefficient of linear expansion of the first optical member, and α₂ (×10⁻⁶ ppm/° C.) is a coefficient of linear expansion of the second optical member.

|α₁−α₂|≦100 (1)

It is preferable that a third optical member formed of curable resin, is joined to an opposite side to a side of the first optical member joined to the second optical member, and that the optical element assembly satisfies a condition represented by Expression (2), where α₃ (×10⁻⁶ ppm/° C.) is a coefficient of linear expansion of the third optical member.

|α₁−α₃|≦100 (2)

It is preferable that the first optical member is formed of glass.

It is preferable that the curable resin is thermosetting resin or photo-curable resin.

It is preferable that the thermosetting resin is any one of acrylic resin, epoxy resin, and allyl ester resin, and that the photo-curable resin is acrylic resin or epoxy resin.

According to another embodiment of the present invention, there is provided an image pickup module comprising: the above-described optical element assembly; and a sensor device for detecting light converged by the optical element assembly.

According to another embodiment of the present invention, there is provided a method for manufacturing an electronic apparatus in which an image pickup module comprising the optical above-descried element assembly and a sensor device for detecting light converged by the optical element assembly, is mounted on a substrate. The method comprises the steps of placing the image pickup module and other electronic components on the substrate on which a material with electrical conductivity is applied in advance; and melting the material with electrical conductivity by submitting a reflow processing to the substrate together with the image pickup module and the other electronic components, to mount the image pickup module and the other electric components onto the substrate simultaneously.

### EFFECTS OF INVENTION

According to the present invention, the difference of coefficients of linear expansion of the first optical member and the second optical member satisfies the condition of Expression (1) to be kept within a certain range, which prevents one of the first optical member and the second optical member from being separated from another even if the optical element assembly is subjected to reflow processing.

### BRIEF DESCRIPTION OF DRAWINGS

FIG. 1 is a schematic perspective view showing an electronic apparatus used in a preferred embodiment of the present invention.

FIG. 2 is an enlarged schematic sectional view showing a peripheral portion of an image pickup device in an electronic apparatus used in a preferred embodiment of the present invention.

FIG. 3 is a perspective view schematically showing external appearance of an optical element assembly in a preferred embodiment of the present invention.

FIG. 4 is a diagram for schematically illustrating a method for manufacturing an optical element assembly in a preferred embodiment of the present invention.

FIG. 5 is a diagram for schematically illustrating a method for manufacturing an electronic apparatus in a preferred embodiment of the present invention.

FIG. 6 is a diagram showing an outline of a condition of reflow processing (a reflow profile) in a preferred example of the present invention.

### REFERENCE SIGNS LIST

100 Electronic apparatus
1 Circuit board
2 Image pickup module
3 Cover case
4 Opening for image pickup
5 Substrate module
6 Lens module
10 Sub-substrate
   10a Fitting hole
11 CCD imaging sensor
12 Resin
15 Lens case
   15a Holder section
   15b Fitting section
16 IR-cut filter
17 Collar member
18 Electroconductive material
20 Optical element assembly
22 First optical member
24 Second optical member
26 Third optical member

### BEST MODE FOR CARRYING OUT THE PRESENT INVENTION

Next, a preferred embodiment of the present invention will be described, with referring to the drawings.

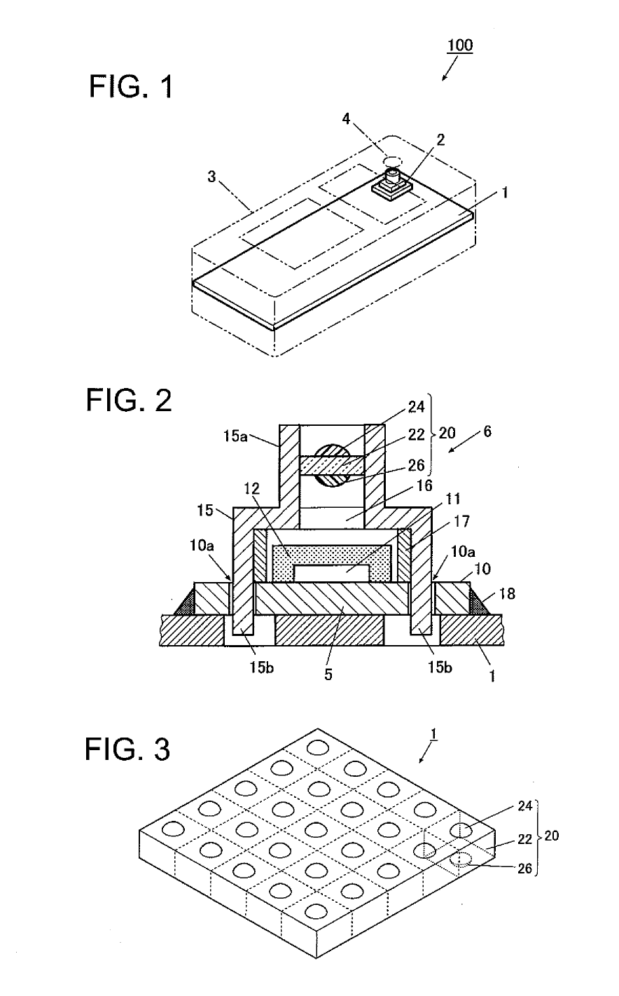

As shown in FIG. 1, electronic apparatus 100 is an example of a small-sized electronic apparatus such as a cell phone with image pickup function, and includes circuit board 1 on which electronic components are mounted. Image pickup module 2 is mounted on circuit board 1. Image pickup module 2 is a small-sized camera to be mounted on a substrate, where a CCD imaging sensor and a lens are combined in the image pickup module. In a completed condition that circuit board 1 on which electronic component are mounted is built in cover case 3, an image of a subject can be taken inside through opening for image pickup 4 formed on cover case 3.

In FIG. 1, illustration of electronic components except electronic components of image pickup module is omitted.

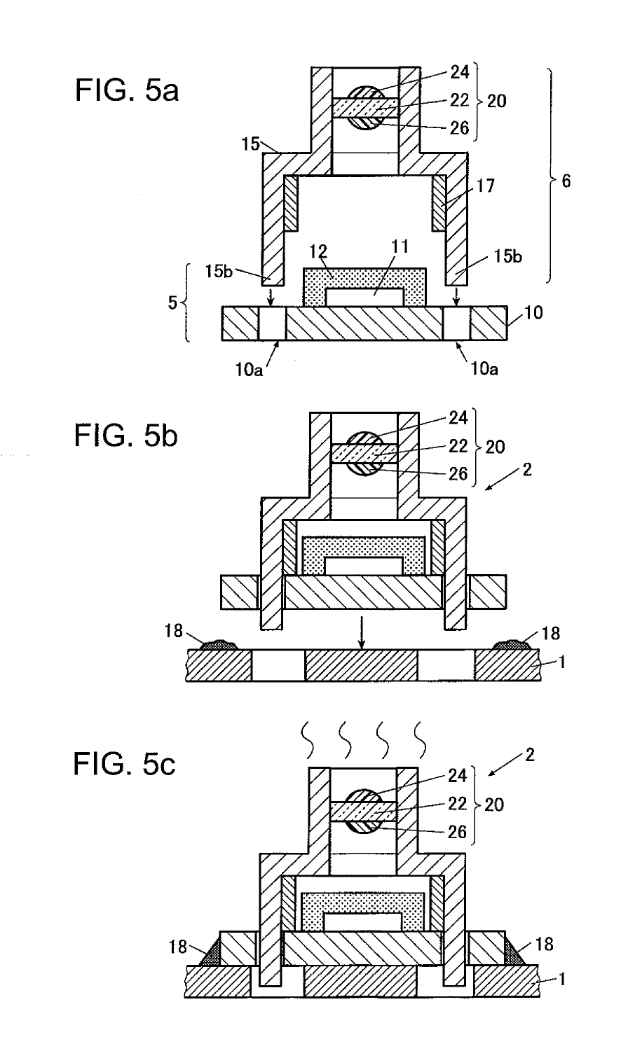

As shown in FIG. 2, image pickup module 2 is composed of substrate module 5 (see FIG. 5a) and lens module 6 (see FIG. 5a). By mounting substrate module 5 onto circuit board 1, the whole of image pickup module 2 is mounted on circuit board 1. Substrate module 5 is a light-receiving module in which CCD imaging sensor 11 for detecting light converged by lens module 6 (specifically, optical element assembly 20) is mounted on sub-substrate 10. The top surface of CCD imaging sensor 11 is sealed by resin 12. The CCD imaging sensor is employed an example of sensor devices.

On the top surface of CCD imaging sensor 11, a light-receiving section (which is not illustrated) in which plural pixels for conducting photoelectric conversion are arranged to form a lattice, is formed. By forming an optical image onto the light-receiving section, electric charges accumulated in respective pixels are outputted as image signal. Sub-substrate 10 is mounted on circuit board 1 with electroconductive material such as solder, thereby, sub-substrate 10 is fixed to circuit board 1 and connecting electrodes (which are not illustrated) of sub-substrate 10 are electrically connected to circuit electrodes (which are not illustrated) on the top surface of circuit board 1.

Lens module 6 is provided with lens case 15. Lens case 15 holds IR-cut filter 16 and optical element assembly 20 therein. The upper portion of lens case 15 forms holder section 15a which holds IR-cut filter 16 and optical element assembly 20.

The lower portion of lens case 15 forms fitting section 15b which is put through fitting hole 10a formed on sub-substrate 10 to fix lens module 6 to sub-substrate 10. For this fixing operation, there are employed a method of carrying out press-fitting and fixing fitting section 15b into fitting hole 10a, and a method of adhering them with adhesive.

In the above electronic apparatus 100, when light enters from opening for image pickup 4, the light passes through optical element assembly 20 and infrared ray is cut with IR-cut filter 16. After that, the light enters CCD imaging sensor 10 and is photoelectrically converted in CCD imaging sensor 10, and an image is generated.

As shown in FIG. 2 and FIG. 3, optical element assembly 20 is an assembly in which first to third optical members 22, 24 and 26 are joined together.

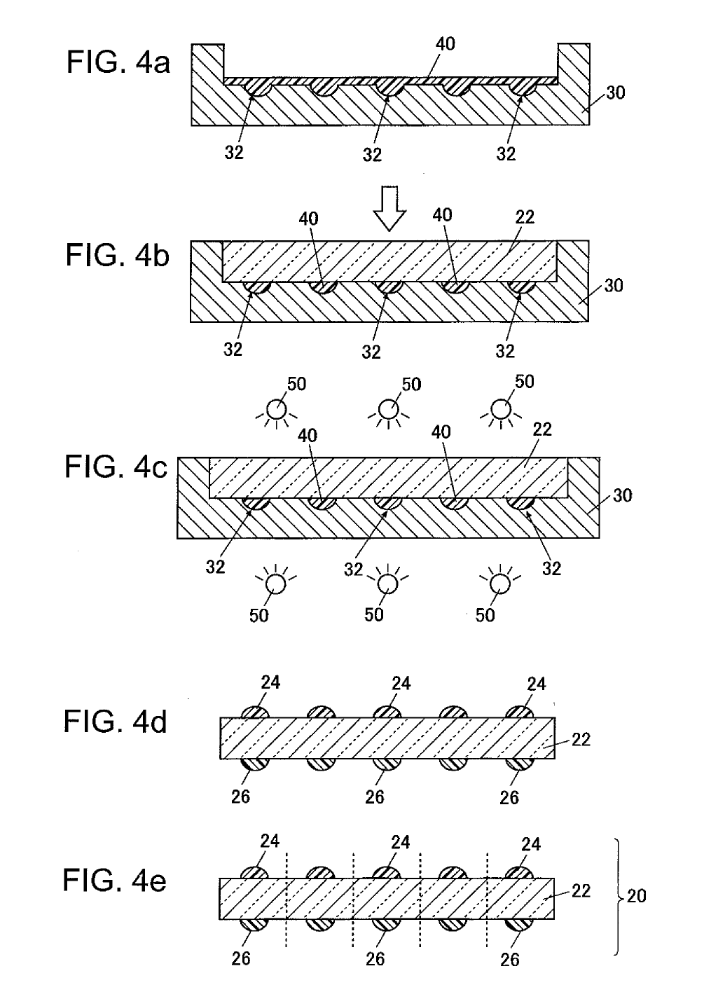

As shown in FIG. 3, optical element assembly 20 is manufactured as follows (see a manufacturing method described below and FIG. 4): plural second and third optical members 24 and 26 are arranged on a sheet of optical member 22 in rectangular shape to form a lattice, and the optical member 22 is cut and separated together with second and third optical members 24 and 26 along a lattice at the time of shipping of products, so that each of the separated bodies is produced as a product (optical element assembly 20).

First optical member 22 is a member to be a base of optical element assembly 20, and is formed of one of transparent lens and transparent photo-curable resin which can transmit light. First optical member 22 basically has a plate shape, but it may have curvature to some degree.

Second optical member 24 is a member in convex shape arranged on the front-surface side (the incident surface where light entering from opening for image pickup 4 enters) of first optical member 22. Second optical member 24 is formed of transparent curable resin which can transmit light.

Third optical member 26 is a member in convex shape arranged on the rear-surface side (an outgoing surface where light entering from opening for image pickup 4 outgoes) of first optical member 22. Third optical member 24 is formed of transparent curable resin which can transmit light.

Second optical member 24 and third optical member 26 are arranged with first optical member 22 interposed between them, and are arranged at corresponding positions on the front surface and rear surface of first optical member 22 (upper side and lower side of FIG. 2), respectively.

Optical element assembly 20 also satisfies the condition of Expression (1), where α₁ (×10⁻⁶ ppm/° C.) is a coefficient of linear expansion of first optical member 22, and α₂ (×10⁻⁶ ppm/° C.) is a coefficient of linear expansion of second optical member 24.

|α₁−α₂|≦100 (1)

Further, Optical element assembly 20 satisfies the condition of Expression (2), where α₃ (×10⁻⁶ ppm/° C. ) is a coefficient of linear expansion of third optical member 26.

|α₁−α₃|≦100 (2)

Coefficients of linear expansion (CTE) of first to third optical members 22, 24 and 26 are measured by an apparatus for thermal mechanical analysis (TMA; Thermal Mechanical Analysis). TMA is an apparatus to measure mechanical properties of heated or cooled samples. TMA is divided broadly into two categories of using a method of measuring a strip of measurement sample with applying a compression load (a mode of compression load), and using a method of measuring a strip of measurement sample with applying a stretch load (a mode of stretch load). In the present embodiment, samples corresponding to first to third optical members 22, 24, and 26 are measured in terms of deformation resulting from a temperature change in the mode of compression load, to obtain the values α₁, α₂, and α₃.

Further, third optical member 26 is not essential, and there may be provided no third optical member.

Next, constituent materials of first to third optical members to satisfy the conditions of Expressions (1) and (2) will be described below.

The second optical member 24 is formed of curable resin, and in more detail, formed of (1) thermosetting resin or (2) photo-curable resin.

### (1) Thermosetting Resin

As the aforesaid thermosetting resin, suitably usable is any one of (1.1) acrylic resin, (1.2) epoxy resin, or (1.3) acrylic ester resin, and these substances will be specifically described below.

### (1.1) Thermosetting Acrylic Resin

### [Resin Component (Monomer Component)]

The aforesaid thermosetting acrylic resin includes (meth)acrylate, and the (meth)acrylate is not particularly limited, and usable are mono(meth)acrylate, polyfunctional (meth)acrylate, which were produced by a general manufacturing method. Preferably used a (meth)acrylate having an alicyclic structure such as tricyclodecane dimethanol acrylate, and isoboronyl acrylate, but commonly used alkyl acrylate, or polyethylene glycol diacrylate can also be used. In addition, the other reactive monomer include mono(meth)acrylate such as methylacrylate, methylmethacrylate, n-butylacrylate, n-butylmethacrylate, 2-ethylhexylacrylate, 2-ethylhexylmethacrylate, isobutylacrylate, isobutylmethacrylate, tert-butylacrylate, tert-butylmethacrylate, phenylacrylate, phenylmethacrylate, benzylacrylate, benzylmethacrylate, cyclohexylacrylate, and cyclohexilmethacrylate.

Polyfunctional (meth)acrylate includes, for example, trimethylolpropane tri(meth)acrylate, pentaerythritol tetra(meth)acrylate, pentaerythritol tri(meth)acrylate, dipentaerythritol hexa(meth)acrylate, dipentaerythritol penta(meth)acrylate, dipentaerythritol tetra(meth)acrylate, dipentaerythritol tri(meth)acrylate, dipentaerythritol octa(meth)acrylate, tripentaerythritol septa(meth)acrylate, tripentaerythritol hexa(meth)acrylate, tripentaerythritol penta(meth)acrylate, tripentaerythritol tetra(meth)acrylate, and tripentaerythritol tri(meth)acrylate.

The aforesaid thermosetting acrylic resin may be a polyester (meth)acrylate having an alicyclic structure, and the polyester (meth)acrylate having an alicyclic structure can be obtained by a dehydration condensation reaction of (a) an ethylenic unsaturated mono carbonic acid, (b) a diol compound, and if necessary, (c) a dicarbonic acid or its acid anhydride, and any one of the above raw materials may use a compound having the alicyclic structure.
(a) The ethylenic unsaturated mono carbonic acid can be exemplified by acrylic acid, methacrylic acid, and acrylic acid dimer. These compounds may be used singly or in combination of two or more.
(b) The diol compound includes ethylene glycol, diethylene glycol, propylene glycol, tripropylene glycol, 1,4-butanediol, 1,6-hexandiol, and neopentyl glycol. As the diol compound having an alicyclic structure, included are hydrogenated bisphenol A, ethylene oxide adduct of hydrogenated bisphenol A, propylene oxide adduct of hydrogenated bisphenol A, cyclohexanedimethanol, ethylene oxide adduct of cyclohexanedimethanol, propylene oxide adduct of cyclohexanedimethanol, norbomane dialcohol, tricyclodecane dimethanol, and adamantane dialcohol. These compounds may be used singly or in combination of two or more.
(c) The dicarbonic acid or its acid anhydride includes succinic acid, succinic anhydride, adipic acid, sebacic acid, fumaric acid, maleic acid, maleic anhydride, itaconic acid, and itaconic anhydride. As the dicarbonic acid or its acid anhydride having an alicyclic structure, included are 1, 4-cyclohanedicarbonic acid, hexahydrophthalic acid, hexahydro phthalic anhydride, methyl hexahydrophthalic acid, methyl hexahydro phthalic anhydride, hydrogenated methyl nadic acid, and hydrogenated methyl nadic anhydride.

These compounds may be used singly or in combination of two or more.

The polyester (meth)acrylate having an alicyclic structure can be synthesized by commonly known methods. For example, the above compounds ca be obtained by a dehydration condensation reaction of (a) an ethylenic unsaturated mono carbonic acid, (b) a dial compound, or if necessary, (c) a dicarbonic acid or its acid anhydride with an acid catalyst under an azeotropic solvent such as benzene, and tluene to remove water. The acid catalyst includes methanesulfonic acid, p-toluenesulfonic acid, and naphthalene sulfonic acid. In view of the reaction rate and strength of cured material, the amount to be added is generally 0.1 to 5% by mass, and preferably 0.3 to 3% by mass, with respect to the total amount of the raw materials.

### [Thermal Polymerization Initiator]

The aforesaid thermal polymerization initiator includes, for example, hydroperoxide, dialkyl peroxide, peroxyester, diacyl peroxide, peroxycarbonate, peroxyketal, and ketone peroxide. Specifically, usable are benzoyl peroxide, diisopropyl peroxycarbonate, t-butylperoxy(2-ethylhexanoate)dicmyl peroxide, di-t-butyl peroxide, t-butyl peroxybenzoate, t-butyl hydroperoxide, diisopropyl benzene hydroperoxide, and 1,1,3,3-tetramethyl butyl hydroperoxide. These thermal polymerization initiators may be used singly or in combination of two or more.

### (1.2) Thermosetting Epoxy Resin

### [Resin Component (Monomer Component)]

As the aforesaid thermosetting epoxy resin, commercially available epoxy compounds are usable. Commercially available epoxy compounds include, for example, bisphenol A type epoxy compounds, such as EPIKOTE 828, EPIKOTE 834, EPIKOTE 1001, and EPIKOTE 1004, which are trade names of Japan Epoxy Resins Co., Ltd., EPICRONE 840, EPICRONE 850, EPICRONE 1050 and EPICRONE 2055, which are trade names of Dainippon Ink and Chemicals Inc., EPOTOTO 128, which is a trade name of Toto-Kasei Co., D.E.R. 317, D.E.R. 331, D.E.R. 661, and D.E.R. 664, which are trade names of Dow Chemical Co., AER 250, AER 260, and AER 2600, which are trade names of Asahi Kasei Chemicals Corp., and SUMIEPDXY ESA-011, SUMIEPDXY ESA-014, and SUMIEPDXY 128, which are trade names of Sumitomo Chemical Co., Ltd.; bisphenol F type epoxy compounds, such as EPICRONE 830S, which is a trade name of Dainippon Ink and Chemicals Inc., EPIKOTE 807, which is a trade name of Japan Epoxy Resins Co., Ltd., EPOTOTO YDF-170, EPOTOTO YDF-175, and EPOTOTO YDF-2004, which are trade names of Toto-Kasei Co., and ARALDITE XPY 306, which is a trade name of Asahi Kasei Chemicals Corp.; bisphenol S type epoxy compounds, such as EBPS-200, which is a trade name of Nippon Kayaku Co., EPX-30, which is a trade name of Adeka Corp., and EPICRONE EXA 1514, which is a trade name of Dainippon Ink and Chemicals Inc.; bisphenol fluorene type epoxy compounds, such as BPFG, which is a trade name of Osaka Gas Co., Ltd., bixylenol type or biphenyl type epoxy compounds or mixtures thereof; such as YL-6065, YL-6021, YX-4000, and YX-4000H, which are trade names of Japan Epoxy Resins Co., Ltd., hydrogenated bisphenol A type epoxy compounds, such as HBE-100, which is a trade name of New Japan Chemical Co., Ltd., and EPOTOTO ST-2004, ST-2007, and ST-3000, which are trade names of Toto-Kasei Co.; brominated bisphenol A type epoxy compounds, such as EPIKOTE YL-903, which is a trade name of Japan Epoxy Resins Co., Ltd., EPICRONE 152, and EPICRONE 165, which are trade names of Dainippon Ink and Chemicals Inc., EPOTOTO YDB-400, and EPOTOTO YDB-500, which are trade names of Toto-Kasei Co., D.E.R. 542, which is a trade name of Dow Chemical Co., AER 8018, which is a trade name of Asahi Kasei Chemicals Corp., and SUMIEPDXY ESB-400, SUMIEPDXY ESB-700, which are trade names of Sumitomo Chemical Co., Ltd.; epoxy compounds having a naphthalene structure, such as ESN-190 and ESN-360, which are trade names of Nippon Steel Chemical Co., Ltd., and HP-4032, EXA-4700 and EXA-4750, which are trade names of Dainippon Ink and Chemicals Inc.; aliphatic epoxy compounds, such as EPOLITE 400E, EPOLITE 400P and EPOLITE 1600, which are trade names of Kyoeisha Chemical Co., Ltd.; and ethylene oxide or propylene oxide added bisphenol A type epoxy compounds, such as EPOLITE 3002, which is a trade name of Kyoeisha Chemical Co., Ltd., but are not limited to them. These compounds may be used singly or in combination of two or more.

As the aforesaid thermosetting epoxy resins, usable are epoxy resins having an alicyclic structure. Epoxy resins having an alicyclic structure include, for example, hydrogenated bisphenol A; reactants of an alicyclic alcohol, such as cyclohexane dimethanol, norbormane dialcohol, tricyclodecane dimethanol and adamantane dialcohol, with an epichlorohydrin; epoxy resins having an alicyclic structure such as 3,4-epoxycyclohexylmethyl-3′,4′-epoxycyclohexane carboxylate, vinylcyclohexene dioxide, limonene diepoxide, 2-(3,4-epoxycyclohexyl)-5,5-spiro-(3,4-epoxycyclohexane)-1,3-dioxane, and bis(3,4-epoxycyclohexyl methyl)adipate. These compounds may be used singly or in combination of two or more.

The ethylenic unsaturated mono carbonic acid includes acrylic acid, methacrylic acid, and acrylic acid dimer. These compounds may be used singly or in combination of two or more.

A reaction between an epoxy group of the epoxy resin having an alicyclic structure and a carboxyl group of the ethylenic unsaturated mono carbonic acid can be carried out without a solvent or by being dispersed or dissolved in a solvent, which is inactive to an epoxy group or a carboxyl group, such as diethyleneglycol ethyl ether acetate, propyleneglycol methyl ether acetate, γ-butyrolactone, methyl isobutyl ketone, diethyleneglycol dimethyl ether, which is then heated to about 80 to about 150° C. In the aforesaid reaction, a reaction catalyst is preferably added to carry out the reaction in an economical time.

As the reaction catalyst, a tertiary amine compound, a phosphine compound, or an onium salt can be used. However, since transparency is required when used for an optical material, an onium salt of quatermary ammonium salt or quaternary phosphonium salt is preferably used. The quaternary ammonium salt includes tetramethyl ammonium chloride, tetrabutyl ammonium chloride, tetramethyl ammonium bromide, tetrabutyl ammonium bromide, decyl tetramethyl ammonium chloride. The quaternary phosphonium salt includes tetraphenyl phosphonium chloride, benzyl triphenyl phosphonium chloride, tetraphenyl phosphonium bromide, and tetramethyl phosphonium tetraphenyl borate.

The amount of the reaction catalyst to be added is, in view of the reaction rate and strength of cured material, is generally 0.1 to 10% by mass, and preferably 0.5 to 5% by mass, with respect to the total amount of the epoxy resin having an alicyclic structure and the ethylenic unsaturated mono carbonic acid.

The percentage of reaction of the epoxy resin having an alicyclic structure and the ethylenic unsaturated mono carbonic acid is preferably 60 mole percent or more, and more preferably 80 mole percent or more.

### [Thermal Polymerization Initiator]

The aforesaid thermal polymerization initiator is used for the polymerization of the above resin component (monomer component), and is not particularly limited. As the thermal polymerization initiator, a curable agent such as an acid anhydride curable agent or a phenol curable agent can be preferably used. The specific examples include phthalic anhydride, maleic anhydride, trimellitic anhydride, pyromellitic anhydride, hexahydro phthalic anhydride, 3-methyl-hexahydro phthalic anhydride, 4-methyl-hexahydro phthalic anhydride, a mixture between 3-methyl-hexahydro phthalic anhydride and 4-methyl-hexahydro phthalic anhydride, tetrahydro phthalic anhydride, nadic anhydride, and methyl nadic anhydride.

### (1.3) Thermosetting Allyl Ester Resin

The aforesaid thermosetting allyl ester resin includes bromine-containing (meth)allyl ester having no aromatic ring (refer to JP-A No. 2003-66201), allyl (meth)acrylate (refer to JP-A No. H5-286896), allyl ester resin (refer to JP-A Nos. H5-286896 and 2003-66201), a copolymer between acrylate and epoxy group-containing unsaturated compound (refer to JP-A No. 2003-128725), an acrylate compound (refer to JP-A No. 2003-147072), and an acrylic ester compound (refer to JP-A No. 2005-2064). Various kinds of additives maybe added to these thermosetting allyl ester resins.

### (2) Photo-Curable Resin

As the aforesaid photo-curable resin, preferably usable is acrylic resin, or epoxy resin, and these substances will be specifically described below.

### (2.1) Photo-Curable Acrylic Resin

### [Resin Component (Monomer Component)]

As the resin component (the monomer component) of the aforesaid photo-curable resin, usable is a component similar to [Resin Component (Monomer Component)] of the above (1.1).

### [Photopolymerization Initiator]

The aforesaid photopolymerization initiator includes various kinds of initiators, but as a characteristic of thick-film materials, it is cited that it is difficult for light to penetrate the interior of the material due to light absorption of the initiator itself Therefore, in the preferred embodiment of the present invention, the photopolymerization initiator in case of using acrylic resin is preferably a high effective initiator having a broad and relatively small absorption band or an absorption edge. The aforesaid photopolymerization initiator includes, for example, α-amino acetophenone, α-hydroxy acetophenone, acylphosphine oxide, and a sensitizer.

In particular, α-amino acetophenone desirably has a long wavelength absorption (325 nm or more in the maximum absorption wavelength), and the specific examples include IRGACURE 369, IRGACURE 379 and IRGACURE 907, manufactured by Ciba Specialty Chemicals Inc. Further, α-hydroxy acetophenone includes IRGACURE 127, manufactured by Ciba Specialty Chemicals Inc.

The amount of the photopolymerization initiator to be added is 0.01 to 10% by mass, preferably 0.1 to 8% by mass, and more preferably 0.5 to 5% by mass, with respect to the resin component.

The blending ratio of the photopolymerization initiator to be contained is 0.001 parts by mass or more, preferably 0.01 parts by mass, and more preferably 0.05 parts by mass, with respect to 100 parts by mass of the resin component. The upper limit is generally one part by mass or less, preferably 0.5 parts by mass or less, and more preferably 0.1 parts by mass or less. If the amount of the photopolymerization initiator to be added is excessively large, the polymerization is dramatically accelerated, and thereby, not only the birefringence of the prepared cured body is increased, but also hues become desaturated. As described in JP-A No.2004-352781 as the commonly known technology, in case where the blending ratio of the photopolymerization initiator to be contained is set to be 5 parts by mass, light does not reach the opposite side where ultraviolet light is irradiated due to an absorption of the photopolymerization initiator, resulting in generation of uncured part. In addition to that, the cured body is colored yellow, to result in significant deterioration of hues. On the other hand, if the amount of the photopolymerization initiator to be added is excessively small, the polymerization may not to sufficiently proceed even if irradiation is carried out.

### (2.2) Photo-Curable Epoxy Resin

### [Resin Component (Monomer Component)]

As the resin component (the monomer component) of the aforesaid photo-curable epoxy resin, usable is a component similar to [Resin Component (Monomer Component)] of the above (1.2).

### [Photopolymerization Initiator]

The aforesaid photopolymerization initiator includes a cationic photopolymerization initiator, and an anionic photopolymerization initiator. Examples of the cationic photopolymerization initiator include a sulfonium salt, an iodonium salt, a diazonium salt, and a ferroeenium salt.

As the examples of the sulfonium salt, preferably usable are ADECA OPTOMER SP-150, and ADECA OPTOMER SP-170, manufactured by Asahi Denka Co., Ltd.; SUNAIDE SI-60L, SI-80L, SI100L, and SI-150, manufactured by Sanshin Chemical Industry Co., Ltd.; CYRACURE UVI-6074, UVI-6990, UVI-6976, and UVI-6992, manufactured by Dow Chemical Co.; and UVACURE 1590, manufactured by Dycel UCB Co.

As the examples of the iodonium salt, preferably usable are UV 9380, manufactured by GE Toshiba Silicones Co., Ltd, and IRGACURE 250, manufactured by Ciba Specialty Chemicals Inc.

The amount of the photopolymerization initiator to be added is 1 to 10 parts, and preferably 4 parts, with respect to 100 parts of the resin component. A curing accelerator may be added, if necessary.

Further, for example, there are benzoin ethers such as benzoin, benzoin methyl ether, benzoin ethyl ether, benzoin isopropyl ether, benzoin phenyl ether, methyl benzoin, and ethyl benzoin. Furthermore, for example, there are combinations between thioxanthone type compounds and tertiary amine compounds, such as a combination between diethyl thioxanthone and dimethylamino benzoic acid.

The amount of the photopolymerization initiator incorporated into the photopolymerizable composite (the whole composite summed by the resin component and the photopolymerization initiator) is 0.01 to 30% by mass, and preferably 0.05 to 10% by mass. If the amount of the photopolymerization initiator is excessively large, the absorption rate of active rays of photopolymerization layer becomes higher, resulting in insufficient setting of the bottom portion of the photopolymerization layer. If the amount of the photopolymerization initiator is excessively small, sufficient sensitivity is not obtained.

It is preferable to incorporate a radical polymerization inhibitor into the photopolymerizable composite to improve heat resistance and storage stability of the photopolymerizable composite. The radical polymerization inhibitor includes, for example, p-methoxyphenol, hydroquinone, pyrogallol, naphthylamine, tert-butylcatechol, cuprous chloride, nitroso phenylhydroxyamine alminum salt, 2,6-di-tert-butyl-p-cresol, 2,2′-methylenebis(4-ethyl-6-ter-butylphenol), and 2,2′-methylenebis(4-methyl-6-ter-butylphenol).

The first optical member 22 is basically constituted of glass, but it may be constituted of resin such as the thermosetting acrylic resin as shown in the above (1.1).

The third optical member 26 is constituted of the similar curable resin to the second optical member 24. In this case, the second optical member 24 and the third optical member 26 may be constituted of the same kind of curable resins with each other, or may be constituted of the different kind of curable resin.

In the present invention, combinations of materials used for the first optical member 22 and the second optical member 24 are not particularly limited, as long as coefficients of linear expansion of the first optical member 22 and the second optical member satisfy the range of Expression (1). In the present invention, it is desired that the difference of the coefficients of linear expansion between the first optical member 22 and the second optical member is small. However, in case where the same resin is used for the first optical member and the second optical member, though separation at the interface is effectively restrained, the whole optical elements are constituted of resins, resulting in a large change in coefficient of linear expansion. Therefore, it is preferable that glass is used for the first optical member, and resin is used for the second optical member within the range that the difference of the coefficients of linear expansion satisfies the range of Example (1). By using glass material for the first optical member, it is possible to restrain deformation of the second optical member by heat.

Next, with reference to FIGS. 4 and 5, a method for manufacturing the electronic apparatus 100 (including a method for manufacturing optical element assembly 20) will be described.

As shown in FIG. 4a, mold 30 which will become a mold for a molding operation is prepared, and curable resin 40 is casted into the mold to all a plurality of cavities 32 with curable resin 40. Cavity 32 of mold 30 exhibits a concave shape corresponding to the shape of second optical member 24. Curable resin 40 is a constitutional material for second optical member 24, and in case where thermosetting resin is used as curable resin 40, a heatable mold made of metal is used as mold 30, and in case where photo-curable resin is used, a light transmissible transparent mold made of glass is used.

Subsequently, as shown in FIG. 4b, first optical member 22 is arranged by pressing from a side of mold 30 on which curable resin 40 was filled, to confine the curable resin 40 in the cavities 32.

In case where curable resin 40 is then thermosetting resin, the curable resin is cured by heating mold 30.

On the other hand, in case where curable resin 40 is photo-curable resin, as shown in FIG. 4c, light sources 50 are switched on to cure curable resin 40. In this case, since both the first optical member 22 and the mold 30 are transparent, light is preferably irradiated on the curable resin 40 from both the top of optical member 22 and under mold 30. The light entered from the top of mold 30 passes through first optical member 22 to reach curable resin 40. On the other hand, the light entered from under mold 30 passes through mold 30 to reach curable resin 40.

The light irradiation may be arranged from either the top of first optical member 22 or under mold 30.

As light source 50, usable are lamps such as H-Lamp (a high pressure mercury lamp), G-Lamp, and F-Lamp. However, as light source 50, from the viewpoint of the stability of light emission, a high pressure mercury lamp having a peak at 365 nm is preferably used. To make the light intensity of the light source 50 uniform, a filter or the like may be, if necessary, placed between light source 50 and first optical member 22 or mold 30.

By the above heating treatment or light irradiation, curable resin 40 is cured, and then, by releasing first optical member 22 from mold die 30, a plurality of second optical members 24 are formed on the surface of first optical member 22. Subsequently, first optical member 22 is turned over, and the treatments of each of steps of FIGS. 4a to 4c are again repeatedly carried out, and as a result, as shown in FIG. 4d, a plurality of third optical members 36 can be formed on the back side of first optical member 22.

After that, as shown in FIG. 4e, first optical member 22 is cut and separated with second and third optical members 24 and 26 to produce a plurality of optical element assemblies 20.

After completion of the production of the optical element assembly 20, substrate module 5 and lens module 6 are assembled, and then, as shown in FIG. 5a, fitting portion 15b of lens case 15 is inserted into fitting hole 10a of sub-substrate 10 until a lower end part of collar member 17 which was in advance equipped in lens case 15, is brought into contact with the upper surface of sub-substrate 10, and is fixed to fitting hole 10a to form an image pickup module 2.

After that, as shown in FIG. 5b, image pickup module 2 and other electronic components are placed at the prescribed mounting position of circuit substrate 1 on which electroconductive material 18 such as solder is in advance applied (potted). Subsequently, as shown in FIG. 5c, circuit substrate 1 on which image pickup module 2 and other electronic components are placed, is transferred to a reflow furnace (not illustrated) by a belt conveyer, and then, the aforesaid circuit substrate 1 is heated at about 230 to about 270° C. for about 5 to about 10 minutes (being reflow processing). As a result of the reflow processing, the electroconductive material 18 is melted to mount image pickup module 2 on circuit substrate 1 together with other electric components. The resulting device is assembled within a cover case 3 to manufacture electronic apparatus 100.

In the present embodiment described above, since the difference of each of coefficients of linear expansion α₁, and α₂ of the first and the second optical members satisfies the condition of Expression (1) and is within a certain definite range, second optical member 24 can be prevented from being separated from first optical member 22, even if image pickup module 2 is subjected to the reflow processing during mounting image pickup module 2 onto circuit substrate 1. Further, since the above relationship is similarly justified to the difference of each of coefficients of linear expansion α₁, and α₃ of the first and the third optical members, third optical member 26 can be prevented from being separated from first optical member 22.

### EXAMPLES

### (1) Preparation of Samples

### Example 1

A glass plate of 1 mm in thickness, the surface of which was polished and smoothed, (BK7 produced by Schott Inc.) was used as the first material.

As the curing initiator, di-tert-butyl peroxide (PERBUTYL D, produced by NOF Corporation) was mixed with 1,10-decandiol diacrylate (NK ESTER A-DOG, produced by Shin-Nakamura Chemical Co., Ltd.), in an amount of 1% of di-tert-butyl peroxide with respect to 1,10-decandiol diacrylate. The resultant mixed solution was used as the second material.

Two ml of the second material was dropped on the first material, and then, the mixture was heated in an oven at 170° C. for 5 minutes to cure the second material. After that, the cured material was let stand under vacuum at 200° C. for one hour (an after curing). The combination of the first and the second materials after being cured was used as a sample of Example 1.

### Example 2

The first material was similar to the one used in Example 1.

80 parts by mass of acid anhydride type curable agent were mixed with 100 parts by mass of alicyclic bisphenol A type liquid epoxy resin (YX8000, produced by JER: Japan Epoxy Resins Co., Ltd.). This mixed liquid was used as the second material.

Two ml of the second material was dropped on the fast material, and then, the mixture was heated in an oven at 130° C. for 5 minutes to cure the second material. After that, the cured material was let stand under vacuum at 150° C. for one hour (an after curing). The combination of the first and the second materials after being cured was used as a sample of Example 2.

### Example 3

The first material was similar to the one used in Example 1.

Poly(diallyl phthalate) (BA901, produced by Showa Denko K.K.) was used as the second material.

Two ml of the second material was dropped on the first material, and then, the mixture was heated in an oven at 110° C. for 30 minutes to cure the second material. After that, the cured material was let stand under vacuum at 130° C. for one hour (an after curing). The combination of the first and the second materials after being cured was used as a sample of Example 3.

### Example 4

The first material was similar to the one used in Example 1.

As the photo curing initiator, 1-hydroxycyclohexyl phenyl ketone (IRGACURE 184, produced by Ciba Specialty Chemicals Inc.) was mixed with trimethyrolpropane tri(meth)acrylate (ARONIX M-309, produced by Tea Gosei Co., Ltd.), in an amount of 0.1% of 1-hydroxycyclohexyl phenyl ketone with respect to trimethyrolpropane tri(meth)acrylate. The resultant mixed solution was used as the second material.

Two ml of the second material was dropped on the first material, and then, the mixture was irradiated by light of 3,000 mJ/cm² using a metal halide lamp to cure the second material. After that, the cured material was heated in a vacuum oven at 150° C. for one hour (an after curing). The combination of the first and the second materials after being cured was used as a sample of Example 4.

### Example 5

The first material was similar to the one used in Example 1.

As the photo curing initiator, one part by mass of aryl sulfonium salt derivatives (SP-172, produced by Adeka Corp.) was mixed with 100 parts by mass of alicyclic epoxy resin (EHPE-3150, produced by Daicel Chemical Industries, Ltd.). This mixed liquid was used as the second material.

Two ml of the second material was dropped on the first material, and then, the mixture was irradiated by light of 5,000 mJ/cm² using a metal halide lamp to cure the second material. After that, the cured material was heated in a vacuum oven at 150° C. for one hour (an after curing). The combination of the first and the second materials after being cured was used as a sample of Example 5.

### Example 6

The acryl resin used as the second material of Example 1 was injected into a space between two glasses with a spacer of 1 mm in thickness, which was then heated in an oven at 170° C. for 5 minutes to cure the second material to produce an acryl plate of 1 mm in thickness. After that, the acryl plate was let stand under vacuum at 200° C. for one hour (an after curing). The acryl plate after being cured was used as the first material.

Two ml of the second material, which was similar to the second material of Example 2, was dropped on the first material, and then, the mixture was heated in an oven at 130° C. for 5 minutes to cure the second material. After that, the cured material was let stand under vacuum at 150° C. for one our (an after curing). The combination of the first and the second materials after being cured was used as a sample of Example 6.

### Examples 7 to 9

The first material was similar to the one used in Example 6.

The second material was similar to the one in Examples 3 to 5, and samples of Examples 7 to 9 were produced by a similar method to Examples 3 to 5.

### Example 10

The first material was similar to the one used in Example 1.

As the curing initiator, di-tent-butyl peroxide (PERBUTYLD, produced by NOF Corporation) was mixed with 1,10-decandiol diacrylate (NK ESTER A-DOG, produced by Shin-Nakamura Chemical Co., Ltd.), in an amount of 1% of di-tert-butyl peroxide with respect to 1,10-decandiol diacrylate. The resultant mixed solution was used as the second and the third materials.

Two ml of the second material was dropped on the first material, and then, the mixture was heated in an oven at 170° C. for 5 minutes to cure the second material. Further, two ml of the third material was also dropped on the back surface of the first material, and then, the mixture was heated in an oven at 170° C. for 5 minutes to cure the third material. After that, the cured material was let stand under vacuum at 200° C. for one hour (an after curing). The combination of the first, second and third materials after being cured was used as a sample of Example 10.

### Example 11

The first material was similar to the one used in Example 1.

As the photo curing initiator, 1-hydroxycyclohexyl phenyl ketone (IRGACURE 184, produced by Ciba Specialty Chemicals Inc.) was mixed with trimethyrolpropane tri(meth)acrylate (ARONIX M-309, produced by Toa Gosei Co., Ltd.), in an amount of 0.1% of 1-hydroxycyclohexyl phenyl ketone with respect to trimethyrolpropane tri(meth)acrylate. The resultant mixed solution was used as the second and third materials.

Two ml of the second material was dropped on the first material, and then, the mixture was irradiated by light of 3,000 mJ/cm² using a metal halide lamp to cure the second material. Further, two ml of the third material was also dropped on the back surface of the first material, and then, the mixture was irradiated by light of 3,000 mJ/cm² using a metal halide lamp to cure the third material. After that, the cured material was heated in a vacuum oven at 150° C. for one hour (an after curing). The combination of the first, second and third materials after being cured was used as a sample of Example 11.

### Example 12

The first material was similar to the one used in Example 1.

As the photo-curing initiator, one part by mass of aryl sulfonium salt derivatives (SP-172, produced by Adeka Corp.) was mixed with 100 parts by mass of alicyclic epoxy resin (EHPE-3150, produced by Daicel Chemical Industries, Ltd.). This mixed liquid was used as the second and third materials.

Two ml of the second material was dropped on the first material, and then, the mixture was irradiated by light of 5,000 mJ/cm² using a metal halide lamp to cure the second material. Further, two ml of the third material was also dropped on the back surface of the third material, and then, the mixture was irradiated by light of 5,000 mJ/an^{e} using a metal halide lamp to cure the third material. After that, the cured material was heated in a vacuum oven at 150 ° C. for one hour (an after curing). The combination of the first, second and third materials after being cured was used as a sample of Example 12.

### Comparative Example 1

The first material was similar to the one used in Example 1.

Part A and Part 13 of addition reaction curable silicone resin (SR-7010, produced by Dow Coming Toray Co., Ltd.) were mixed by 1:1, and the mixture was used as the second material.

Two ml of the second material was dropped on the first material, and then, the mixture was heated in an oven at 150° C. for one hour to cure the second material. After that, the cured material was let stand under vacuum at 180° C. for one hour (an after curing). The combination of the first and the second materials after being cured was used as a sample of Comparative Example 1.

### Comparative Example 2

The first material was similar to the one used in Example 6.

Part A and Part B of addition reaction curable silicone resin (SR-7010, produced by Dow Corning Toray Co., Ltd) were mixed by 1:1, and the mixture was used as the second material.

Two ml of the second material was dropped on the first material, and then, the mixture was heated in an oven at 150° C. for one hour to cure the second material. After that, the cured material was let stand under vacuum at 180° C. for one hour (an after curing). The combination of die first and the second materials after being cured was used as a sample of Comparative Example 2.

### [Comparative Example 3]

The first material was similar to the one used in Example 1.

Part A and Part B of addition reaction curable silicone resin (SR-7010, produced by Dow Coming Toray Co., Ltd.) were mixed by 1:1, and the mixture was used as the second and third materials.

Two ml of the second material was dropped on the first material, and then, the mixture was heated in an oven at 150° C. for one hour to cure the second material. Further, two ml of the third material was also dropped on the back surface of the first material, and then, the mixture was heated in an oven at 150° C. for one hour to cure the third material. After that, the cured material was let stand under vacuum at 180° C. for one hour (an after curing). The combination of the first, second and third materials after being cured was used as a sample of Comparative Example 3.

Table 1 shows the combinations of the first, second and third materials of each of samples of the above Examples 1 to 12 and Comparative Examples 1 to 3. (The manufacturer and the grade of each material are also shown in the lower part of Table 1.)

In the samples of Examples 1 to 12 and Comparative Examples 1 to 3, the first, second and third materials indicate materials of members corresponding to the first optical member 22 of FIGS. 2 and 3, the second optical member 24 of FIGS. 2 and 3, and the third optical member 26 of FIGS. 2 and 3, respectively.

TABLE 1

| Sample | First Material | Second Material | Third Material |
|---|---|---|---|
| Example 1 | Glass | Thermosetting | — |
| | | Acrylic | |
| Example 2 | | Thermosetting Epoxy | |
| Example 3 | | Thermosetting Allyl | |
| | | Ester | |
| Example 4 | | UV Curable Acrylic | |
| Example 5 | | UV Curable Epoxy | |
| Example 6 | Thermosetting | Thermosetting Epoxy | — |
| Example 7 | Acrylic | Thermosetting Allyl | |
| | | Ester | |
| Example 8 | | UV Curable Acrylic | |
| Example 9 | | UV Curable Epoxy | |
| Example 10 | Glass | Thermosetting | Thermosetting |
| | | Acrylic | Acrylic |
| Example 11 | | UV Curable Acrylic | UV Curable Acrylic |
| Example 12 | | UV Curable Epoxy | UV Curable Epoxy |
| Comparative Example 1 | | Silicone | — |
| Comparative Example 2 | Thermosetting | Silicone | — |
| | Acrylic | | |
| Comparative Example 3 | Glass | Silicone | Silicone |

| Type of Material | Manufacturer | Grade Name |
|---|---|---|
| Glass | Schott | BK7 |
| Thermosetting Acrylic | Shin-Nakamura Chemical | NK Ester A-DOG |
| Thermosetting Epoxy | JER | YX8000 |
| Thermosetting Allyl Ester | Showa Denko | BA901 |
| UV Curable Acrylic | Toa Gosei | ARONIX |
| UV Curable Epoxy | Dycel UCB | EHPE-3150 |
| Silicone | Dow Corning Toray | SR7010 |

### (2) Determination of Coefficient of Linear Expansion

Aside from the production of the samples of Examples 1 to 12 and Comparative Examples 1 to 3, for the constitutional material of each sample (the first to third materials), a single plate of 1 mm in thickness (in a state of not being connected) was made, and then, the average coefficient of linear expansion (being in conformity to HS K7197) of the constitutional material of each sample was determined.

In the determination, a thermal stress-strain measuring apparatus, TMA/SS120C, manufactured by Seiko Instruments Inc., was used, and, under nitrogen gas atmosphere, the temperature was raised from 30° C. to 300° C. at a rate of 5° C./min and sustained for 20 minutes. Values during 30 to 150° C. were measured to determine the average coefficient of linear expansion. The measured coefficients of linear expansion were shown in Table 2 for each sample, and in addition, the difference of the coefficients of linear expansion between the first and second materials (|α₁−α₂|), and the difference of the coefficients of linear expansion between the first and third materials (|α₁−α₂|), were also shown in Table 2.

In Table 2, “forming time” of each sample was also shown. In case where the first to third materials were resin, the forming time indicates a time on the assumption that it was possible to take out a molded product from a mold considering that a state of something like liquid being not left on the surface of the molded product means the molded product was cured, and therefore, the after curing time is not included in the forming time.

### (3) Evaluation of Sample

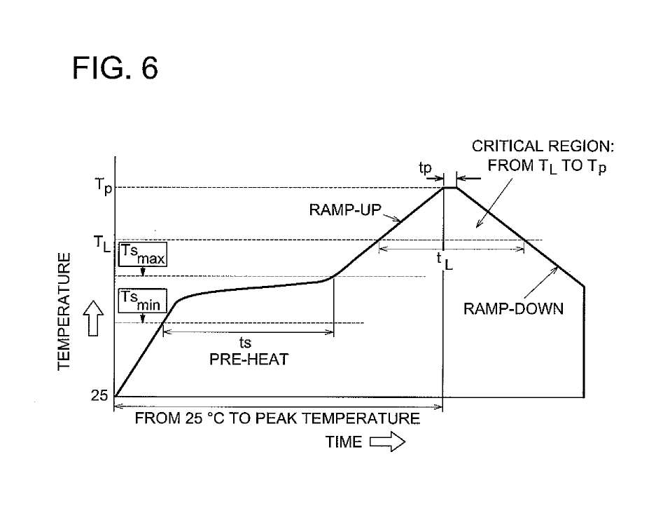

The maximum height of each sample (being in conformity to MS B0601; hereinafter expressed by “Ry”) was determined using an interferometer, manufactured by Zygo Corp. After that, the reflow processing as shown in FIG. 6 was repeated by three times for each sample. Specifically, in the reflow processing of FIG. 6, the “average run-up speed (a speed from Tsₘₐₓ to Tp)” was set to maximum 3° C./sec., the “preheating minimum temperature (Tsₘᵢₙ)” was set to 150° C., the “preheating maximum temperature (Tsₘₐₓ)” was set to 200° C., the “preheating time (a time from tsₘᵢₙ to tsₘₐₓ)” was set to 60 to 180 sec., the “sustaining temperature (T_{L})” was set to 217° C., the “sustaining time (t_{L})” was set to 60 to 150 sec., the “peak time (tp)” was set to 20 to 40 sec., the “run-down speed” was set to maximum 6° C./sec., and the “time from 25° C. to the peak temperature” was set to maximum 8 minutes.

### (3.1) Appearance Inspection

The appearance of each sample after reflow processing was examined. The results were given in Table 2. In Table 2, the criteria A and B are as described below.

A: No separation or rise of the second or third material is observed.

B: Separation or rise of the second or third material is observed.

### (3.2) Determination of ΔRy

The Ry, which was measured before the reflow processing, was again measured after the reflow processing for each sample, and then, the rate of change of the Ry (ΔRy) before and after the reflow processing was calculated. The results are given in Table 2. In Table 2, the criteria A and B are as described below.

A: The ΔRy is less than 1 μm.

B: The ΔRy is 1 μm or more.

TABLE 2

| | Coefficient of Linear Expansion | | | | | | | |
|---|---|---|---|---|---|---|---|---|
| | (×10⁻⁶ ppm/° C.) | | | Difference of Coefficients of | | | | |
| | | Second | | Linear Expansion | | | | |
| Sample | First Material | Material | Third Material | \|α₁ − α₂\| | \|α₁ − α₃\| | Forming Time | Appearance | ΔRy |
| Example 1 | 9 | 73 | — | 64 | — | 5 minutes | A | A |
| Example 2 | | 85 | | 76 | | 5 minutes | | |
| Example 3 | | 64 | | 55 | | 30 minutes | | |
| Example 4 | | 60 | | 51 | | 1.5 minutes | | |
| Example 5 | | 72 | | 63 | | 3 minutes | | |
| Example 6 | 73 | 85 | — | 12 | — | 10 minutes | | |
| Example 7 | | 64 | | 9 | | 35 minutes | | |
| Example 8 | | 60 | | 13 | | 6.5 minutes | | |
| Example 9 | | 72 | | 1 | | 8 minutes | | |
| Example 10 | 9 | 73 | 73 | 64 | 64 | 10 minutes | | |
| Example 11 | | 60 | 60 | 51 | 51 | 3 minutes | | |
| Example 12 | | 72 | 72 | 63 | 63 | 6 minutes | | |
| Comparative | | 188 | — | 179 | — | one hour | B | B |
| Example 1 | | | | | | | | |
| Comparative | 73 | 188 | — | 115 | — | one hour and | A | B |
| Example 2 | | | | | | 5 minutes | | |
| Comparative | 9 | 188 | 188 | 179 | 179 | two hour | B | B |
| Example 3 | | | | | | | | |

### (4) Summary

As shown in Table 2, the samples of Examples 1 to 12 were excellent in both appearance and ΔRy value, compared to the samples of Comparative Examples 1 to 3, showing that the samples of Examples 1 to 12 had results to withstand the reflow processing. It was found from the above results that in case where the difference of the coefficients of linear expansion between materials which were connected with each other (between the first and second materials or the first and third materials) was 100 or less, one optical member could be prevented from being separated from the other even if the members were subjected to the reflow processing.

1. An optical element assembly comprising:
a first optical member formed of glass or curable resin; and
a second optical member formed of curable resin,
wherein the first optical member and the second optical member are joined together, and the optical element assembly satisfies a condition represented by Expression (1):

|α₁−α₂|≦100 (1)
where α₁ (×10⁻⁶ ppm/° C.) is a coefficient of linear expansion of the first optical member, and
α₂ (×10⁻⁶ ppm/° C.) is a coefficient of linear expansion of the second optical member.

2. The optical element assembly of claim 1, further comprising
a third optical member formed of curable resin, joined to an opposite side to a side of the first optical member joined to the second optical member,
wherein the optical element assembly satisfies a condition represented by Expression (2):

|α₁−α₂≦100 (2)
where α₃ (×10⁻⁶ ppm/° C.) is a coefficient of linear expansion of the third optical member.

3. The optical element assembly of claim 1,
wherein the first optical member is formed of glass.

4. The optical element assembly of claim 1,
wherein the curable resin is thermosetting resin or photo-curable resin.

5. The optical element assembly of claim 4,
wherein the thermosetting resin is any one of acrylic resin, epoxy resin, and allyl ester resin.

6. The optical element assembly of claim 4,
wherein the photo-curable resin is acrylic resin or epoxy resin.

7. An image pickup module comprising:
the optical element assembly of claim 1; and
a sensor device for detecting light converged by the optical element assembly.

8. A method for manufacturing an electronic apparatus in which an image pickup module comprising the optical element assembly of claim 1 and a sensor device for detecting light converged by the optical element assembly, is mounted on a substrate, the method comprising the steps of:
placing the image pickup module and electronic components on the substrate on which an electroconductive material has been applied in advance; and
melting the electroconductive material by submitting a reflow processing to the substrate together with the image pickup module and the electronic components, to mount the image pickup module and the electric components onto the substrate simultaneously.
